(19) United States
(12) Patent Application Publication
(10) Pub. No.: US 2022/0200434 A1
(43) Pub. Date: Jun. 23, 2022

(54) VARIABLE POWER MAGNETOHYDRODYNAMIC ACCELERATOR, COMPRESSOR, AND MIXER FOR FLUIDS, WITH REGENERATIVE ELECTRICAL GENERATION SYSTEM

(71) Applicant: Brant von Goble, Lansing, MI (US)

(72) Inventor: Brant von Goble, Lansing, MI (US)

(21) Appl. No.: 17/128,117

(22) Filed: Dec. 20, 2020

(51) Int. Cl. H02K 44/04

(52) U.S. Cl. CPC H02K 44/04

(57) ABSTRACT

A variable-power magnetohydrodynamic accelerator, mixer, and compressor for fluids, consisting of several parts, including 1) an array of spiraled adjustable-power accelerators (SAPAs), with integrated electrostatic-pre-charging components (EPCCs) and electromagnetic accelerator components (EACs); and 2) a multi-shell core with cooling system.

### CROSS REFERENCES TO RELATED APPLICATIONS

This application claims the benefits of U.S. Provisional Patent Application No. 63/064,419, filed Aug. 12, 2020, with the text of that claim incorporated herein.

### BRIEF DESCRIPTION OF INVENTION

The invention is made of several parts, including spiraled adjustable-power accelerators (SAPAs) and a multi-shell core with cooling system. These function together to allow for the acceleration, mixing, compression, and depressurization of various fluids, either alone or in combination with other compatible fluids.

Each SAPA consists of multiple hollow pumping lines with electrostatic-pre-charging components (EPCCs) located near the input point/aperture of each line and with electromagnetic accelerator components (EACs) spaced evenly along the remaining line length. Pumping lines are constructed in a non-intersecting spiral shape and gradually decrease in diameter as they approach the core.

As an electrostatically charged fluid is accelerated through a SAPA by way of the magnetohydrodynamic effect, it is forced under greater pressure through the SAPA pumping lines, which taper from their initial diameter (400 mm) to a narrower diameter (10 mm). The end of each accelerator line passes through an outer containment core and a heat-exchange/pressure maintenance (cooling) void, terminating inside the shell of the inner core, where interior pressure increases with the ongoing operation of the system until equilibrium between accelerator line and core pressure is achieved.

The operation of the invention allows for high-pressure mixing and the creation of pressure-dependent material states. Depending upon power levels applied to the electrostatic pre-charging and electromagnetic accelerator components of the SAPAs, both the rate of core-pressure increase and the total core pressure can be precisely managed. Additionally, individual EACs of each SAPA can be separately controlled, allowing for manipulation of acceleration rates along the pumping lines, regulation of core-entry velocities of fluids, and the pulsed injection of fluids into the core.

The invention also has the advantage of a lack of moving parts (excluding external feeder pumps, which are not part of the invention itself). This simplicity of design and construction will increase the time between maintenance sessions and simplify the repair and cleaning of the invention. Finally, the unique pumping-line port arrangement in the inner core allows for the generation of fluid spin, from slow to cyclonic, within the inner core.

By decreasing the power applied to EACs, the operator can allow for the controlled release of compressed fluids from the invention's core. Although this would typically be done using a symmetrical reduction in power along all lines (to prevent core distortion from uneven depressurization), the operator will have the option of controlling EAC power levels individually in case compressed fluid need be released asymmetrically.

Polarity reversal of the EACs and EPCCs allows for the charging and injection of fluids into the core using either the same or opposing polarities, which will itself facilitate control of fluid interaction within the inner core.

Finally, control of fluid flow rates through the cooling cavity between the inner and outer core will allow for the operator to control both inner core temperature, and if needed, to increase inner-core pressure tolerance by way of static fluid (hydraulic) reinforcement.

### BACKGROUND OF INVENTION

### 1. Field of the Invention

The compression of fluids has a range of industrial and scientific applications. At low levels, pressure and heat are used to create conventional mixtures and chemical formulations; at medium or high pressures, complex polymers; and at higher pressures, diamond and diamond-like matter. At extremely high pressure and energy levels, fusion can occur; however, maintaining a fusion reaction within a vessel for any length of time requires confinement systems with which the core of the present invention is not equipped.

Conventional pumping systems are limited in their ability to compress fluids beyond very limited levels and at certain rates. And interaction with the moving parts of conventional pumps poses contamination risks. Additionally, most pumping systems do not allow for controlled, direction-specific pressure application within the pressure vessel/core, nor do they allow for the easy introduction of complex mixtures into the pressure vessel with the injection timing of multiple chemical/compounds being precisely controlled. The present invention addresses all these limitations.

Magnetohydrodynamic acceleration allows for the movement of fluids without using any moving parts or conventional pumping mechanisms. This is the principle that will be used to operate the invention.

Additionally, the magnetohydrodynamic effect can be used to generate electricity without the use of lubricants, gears, or other easily damaged components as fluids exit the pressure chamber by way of the SAPAs.

### 2. Discussion of the Prior Art

Magnetohydrodynamic Effect—

The magnetohydrodynamic effect (MHDE) allows for the acceleration of electrostatically pre-charged fluids by way of the application of magnetic fields. The efficiency of the MHDE is limited by the conductivity of the charged fluid, thermal and current limitations, and the potential of the fluid to decompose into its components when an electrostatic charge is applied to it. The last limitation is particularly relevant when passing water through an EPCC, converting it into hydrogen and oxygen by way of electrolysis if excessive current is applied.

The magnetohydrodynamic effect (MHDE) has been applied at a variety of scales and with varying degrees of efficiency, with physically smaller applications proving more economically feasible than larger ones. The MHDE can also be used for the generation of electricity, with the charged fluid flowing past or through magnetic fields and inducing a current.

Patents and publications related to the magnetohydrodynamic effect (MHDE) are described, infra.

As Propulsion Device
G. Iddan, “Self Propelled Device Having a Magnetohydrodynamic Propulsion System,” U.S. Pat. No. 6,939,290 B2 (Sep. 6, 2005) describes a MHDE propulsion system used for directing the movement of in-vivo medical sensors and remote self-propelled sensors for industrial, medical, and commercial purposes, with the fluid used in the propulsion system being either an appropriate electrically conductive fluid (such as saline) or gastrointestinal fluid (when the self-propelled device is used with the body).
A. Lemoff, et al., “Magnetohydrodynamic Pump with a System for Promoting Flow of Fluid in One Direction,” U.S. Pat. No. 7,753,656 B2 (Jul. 13, 2010) describes an MHDE propulsion apparatus with a microfluidic channel and system for promoting the unidirectional flow of fluids, with the system having a complex channel geometry to prevent, without the use of valves, back flow of fluids.
A. Lee, et al., “Magnetohydrodynamic Fluidic System,” U.S. Patent Application No. 2003/0234220 A1 (Dec. 25, 2003) describes an apparatus for mixing sample source fluids (with constituents) and reagents with magnetohydrodynamic pumps so that the sample fluid and constituent are separated by interaction with the reagent.

As Electrical Generation Device
W. Kafka, “Magnetohydrodynamic Generator,” U.S. Pat. No. 3,146,361 (Aug. 25, 1964) describes an apparatus that relies upon the movement of a heated (rising) ionized solution through magnetic fields for the generation of electricity without the use of moving parts.
R. Ribard, “Process and Apparatus for Transforming Caloric Energy into Electrical Energy Along a Thermodynamic Cycle Comprising At Least One Magnetohydrodynamic System,” U.S. Pat. No. 3,450,904 (Jun. 17, 1969) describes a closed-loop system that relies upon the movement of heated (rising) liquid metal and a fine-bubble gas through a magnetic field to generate electricity by way of the magnetohydrodynamic effect.

Patents and publications related to the use of electromagnetic fields for mixing are described, infra.
J. Birat, et al., “Method and Apparatus for Electromagnetic Mixing of Metal During Continuous Casting,” U.S. Pat. No. 4,178,979 (Dec. 18, 1979) describes as system for mixing molten metals using electromagnetic fields applied to a mold that narrows from the entry point to the exit point.

Patents and publications related to the use of fluid rotation within a chamber for mixing are described, infra.
K. Rock, “Fluid Processing System and Method,” U.S. Pat. No. 6,648,306 B2 (Nov. 18, 2003) describes an apparatus for the mixing of fluids within a cylindrical vortex chamber fed by an array of tangential apertures running along a portion of the cylinder's wall.
C. Hallberg, et al., “Vortex Generator with Vortex Chamber,” U.S. Patent Application No. 2012/0097280 A1 (Apr. 26, 2012) describes an apparatus for creating a vortex within a tapered chamber for the purpose of mixing fluids.

Patents and publications related to the use of ceramics for the construction and assembly of high-pressure/high-temperature resistant components and electromagnetic components, such as the invention's core and various mechanisms of the spiraled adjustable-power accelerators (SAPAs), infra.
K. Schofalvi, et al., “Thermal Shock Resistant Ceramic Composites,” U.S. Pat. No. 7,666,344 B2 (Feb. 23, 2010) describes ceramic composites that can tolerate sudden changes in temperature without cracking or rupturing.
K. Friese, “Thermal Shock Resistant Ceramic,” U.S. Pat. No. 5,681,784 (Oct. 28, 1997) describes a homogenous ceramic mixture that can tolerate sudden changes in temperature without cracking or rupturing.
S. Conzone, et al., “Glass Ceramic Composites,” U.S. Patent Application No. 2004/0247826 A1 (Dec. 9, 2004) describes a system for joining sections of ceramics at low temperatures using a silicate liquid.
T. Jones, et al., “Ceramic Superconducting Magnet Using Stacked Modules,” U.S. Pat. No. 5,426,408 (Jun. 20, 1995) describes a system for the construction of superconducting magnet modules comprised of abutting superconducting magnetic components.
W. Easter, et al., “Additive Manufacturing 3D Printing of Advanced Ceramics,” U.S. Pat. No. 9,944,021 B2 (Apr. 17, 2018) describes methods and a system for the production of ceramic composites in complex shapes using a spreadable slurry and Selective Laser Melting.

Patents and publications related to the controlled decompression of a chamber, infra.
E. Ting, et al., “Systems and Methods to Slowly Reduce the Pressure in a Pressure Chamber Over Time,” U.S. Pat. No. 7,537,019 B2 (May 26, 2009) describes a system and a method for the stepwise depressurization of a high-pressure chamber using electromechanically controlled valves and a secondary small pressure chamber with minimal risk of explosive decompression.

Patents and publications describing conventional pumping mechanisms and their limitations, infra.
Yano et al., “Scroll Compressor,” U.S. Pat. No. 7,909,592 B2 (Mar. 22, 2011) describes an improved scroll compressor that has a simple scroll structure and does not require a thrust bearing, but that, despite its improvements, requires constant interaction between moving parts in the compressor and the fluid being compressed, requires a lubricant, and is unable to produce an entirely non-turbulent flow.
R. Burr, et al., “Linear Resonance Pump and Methods for Compressing Fluid,” U.S. Pat. No. 6,514,047 B2 (Feb. 4, 2003) describes an apparatus for cyclically compressing fluids by use of a flexible metal diagram attached to a rigid compression chamber, with the mechanism being unable to produce continuous and entirely non-turbulent flow.
C. Capone, et al., “Continuous Fluid Delivery System and Method,” U.S. Patent Application No. 2015/0273137 A1 (Oct. 1, 2015) describes a system for pumping and mixing fluids by way of opposing pistons, with the mechanism producing continuous but not entirely non-turbulent flow.
T. Krenik, “Air Cycle Heat Pump Techniques and System,” U.S. Pat. No. 8,591,206 B2 (Nov. 26, 2013) describes an apparatus consisting of a plurality of electrically activated vanes that allow for the efficient compression of a fluid in proximity to a heat exchanger, with the fluid being compressed being in constant contact with the moving components of the compressor system.
H. Sakurai, et al., “Electromagnetic Compressor and Manufacturing Method Therefor,” U.S. Patent Application No. 2002/0136650 A1 (Sep. 26, 2002) describes an apparatus for compressing fluids by way of a reciprocating piston actuated by an electromagnet and returned to its original position by a spring, with the mechanism producing flow that is neither continuous nor non-turbulent.

### FEATURES OF INVENTION

It is a feature of the present invention to allow for extremely variable pumping and pressure rates, with highly dynamic flow rates and reversible direction of flow being feasible.

It is a feature of the present invention to allow for the compression of fluids without interacting with moving parts.

It is a feature of the present invention to allow for the introduction of highly complex, multi-substance formulations into the core pressure vessel (the inner core), with the timing and rate of substance entry being precisely controllable. This is a result of each SAPA having 16 entry channels and there being a total of 8 SAPAs in the complete invention (for a total of 128 ports into the inner core). Changes to power levels applied to the individual magnetic accelerator components of each SAPA pumping line allow for the operator to control the rate, timing, and velocity at which each substance is introduced into the core.

It is a feature of the present invention to allow for the creation of rotation of fluids or mixtures of fluids within its inner core. This rate of rotation within the core is variable, ranging from the slow to the cyclonic, depending upon the rate at which fluids are introduced to the core.

It is a feature of the present invention to allow for the controlled, non-explosive directional or omnidirectional depressurization of the core, with pressurized substances released from the core being cooled at a controllable rate as a virtue of the tapered pumping lines.

It is a feature of the present invention to allow for the generation of electricity by way of the magnetohydrodynamic effect (MHDE) as fluids exit the core and pass outward through the tapered pumping/inflow/outflow lines.

It is a feature of the present invention to allow construction of pumping lines and cores from a diverse range of materials, affording embodiments of the invention considerable resistance to shock, heat, and chemical attack—none of which could be as easily tolerated by ordinary compressor systems with moving parts.

### BRIEF DESCRIPTION OF DRAWINGS OF INVENTION

The patent or application file contains at least one drawing executed in color. Copies of this patent or patent application publication with color drawing(s) will be provided by the Office upon request and payment of the necessary fee.

The features, aspects, advantages, and operation of the present invention will become better understood by referencing the appended descriptions and claims, and the accompanying drawings wherein:

FIG. 1. is a left-side view of the entirety of an embodiment of the invention, indicating the placement of the spiraled adjustable-power accelerators (SAPAs), the placement of the electrostatic-pre-charging components (EPCCs) (in orange), the size of the outer core (and its placement), and the total height of the invention. This view assumes that the embodiment of the invention will be placed upright; however, the invention may be constructed and operated at any angle.

FIG. 2 is an isometric southwest (SW) view of a single SAPA/adjustable-power compressor, with the input (201) and output (202) ports of the pumping lines labeled.

FIG. 3 is a left-side view of a single SAPA, with the narrowing dimensions of the accelerator marked at 16 points.

FIG. 4 is a left-side view of a single SAPA, with the narrowing dimensions of the pumping lines indicated at 4 points. Each marker indicates the dimension of the pumping lines at that given point, with the line between the markers gradually narrowing until reaching the diameter indicated at the next marker. The widest section (at 400 mm) of each SAPA is the electrostatic-pre-charging component, and the narrowest (10 mm) is the pumping line section that approaches and enters the core.

FIG. 5 is a left-side view of a single SAPA, with the measurements used for magnetic-accelerator-component spacing clearly indicated (502). Although the magnetic components will be spaced at intervals along the length of the pumping lines (excluding the EPCCs, as seen in 501), this illustration only indicates the placement of them on a section of the lines. This is done purely for the sake of visual economy.

FIG. 6 is a closeup from FIG. 5 (502) with the actual EACs made visible in yellow.

FIG. 7 is a closeup of the left-side view of a portion of a single SAPA, with EACs indicated as being of a larger diameter and different color (yellow) (702) from the non-magnetic lengths of the pumping lines (701).

FIG. 8 is a closeup of the isometric southwest (SW) view of a portion of a single SAPA, with EACs indicated in yellow, and the non-magnetic lengths indicated in distinctive line-specific colors.

FIG. 9 and FIG. 10 are isometric southwest (SW) and isometric northwest (NW) views of the entirety of the embodiment of the invention, with solid black guidelines drawn outside of the embodiment to illustrate the direction of the frontal plane as seen in FIG. 1.

FIG. 11 is a closeup dimetric northwest (NW) view of the outer core of the invention (1101), with the cold coolant input indicated with blue (1102), and the hot (output) side of the coolant system indicated in red (1103).

FIG. 12 is a cutaway close-up dimetric northwest (NW) view of the core of the invention, with the outer core indicated in yellow (1201), the void between the cores (1202), and the inner core indicated in red (1203).

FIG. 13 is a cutaway close-up dimetric northwest (NW) view of the core of the invention, with the staggered entry angles of the pumping lines into the inner core clearly illustrated (1301).

FIG. 14 is a view of the invention embodiment's inner and outer cores and core cooling system, with dimensions, including core diameters, material thickness, and core spacing.

### EXPLANATION OF POINTS ILLUSTRATED BY DRAWINGS OF INVENTION

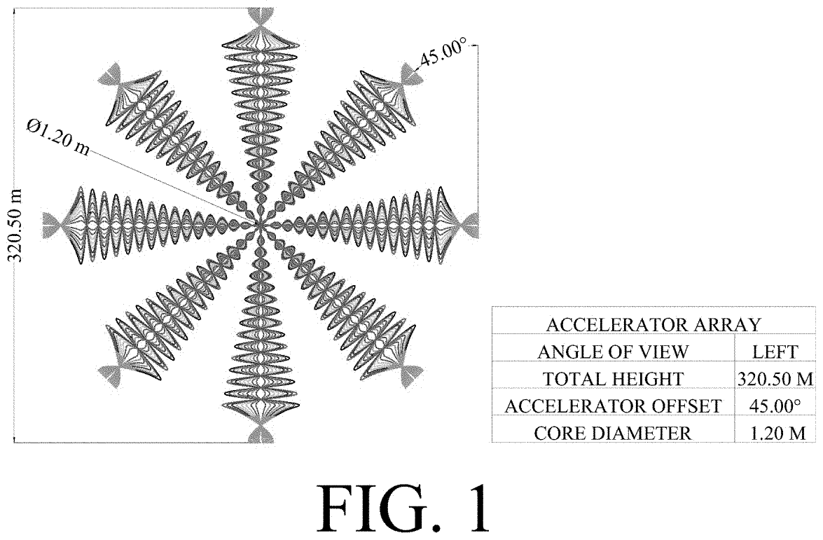

The preferred embodiment of the present invention is illustrated in FIG. 1 through FIG. 14, with each drawing demonstrating a different aspect of said invention. FIG. 1 demonstrates the complete layout of the invention, which consists of 8 SAPAs arranged into an equally spaced array, with the center of each accelerator being offset 45 degrees from its nearest neighbors.

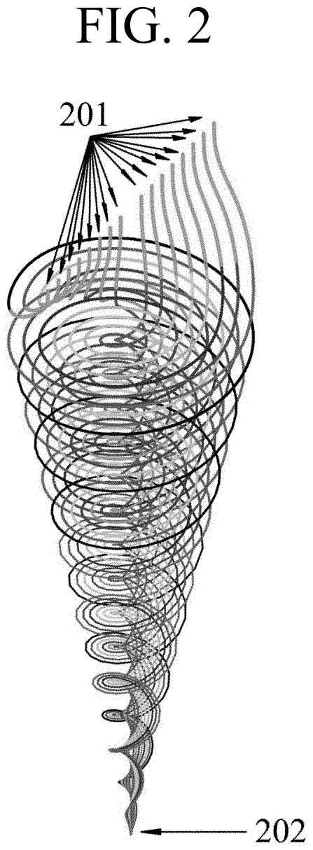

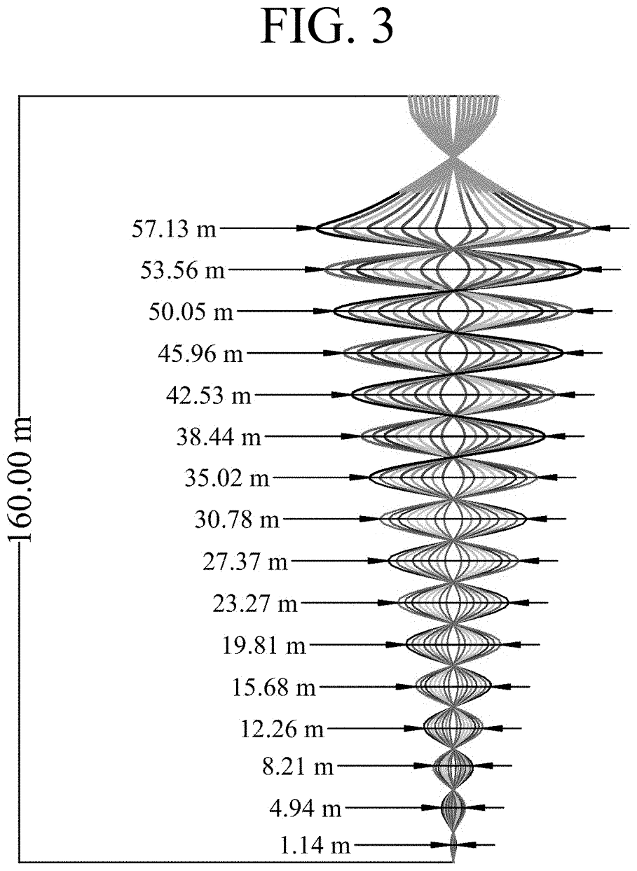

FIG. 2 and FIG. 3 illustrate the specific shape of a single SAPA. The design of this accelerator is novel, in that it relies on a spiral shape, rather than a circular one. This makes the embodiment of the accelerator more compact and allows a greater number of magnetic elements to be spaced along the length of the pumping/acceleration coil than could be done with more conventional shapes. The colors used throughout these figures and FIG. 1 through FIG. 14 serve to allow for the easy distinction of one pumping line from another, not to indicate any specific difference in pumping line power levels or dimensions, with the EPCCs indicated in yellow on the outer edge of the SAPAs.

FIG. 3 demonstrates a feature of the SAPAs used in this invention, in that the initial entry spiral is large, but the size and angle of the accelerator change in such a way to allow for many coils and lines to terminate in the comparatively small inner core of the invention. This trait is particular to a spiral-shaped device, whereas round devices would not have this trait.

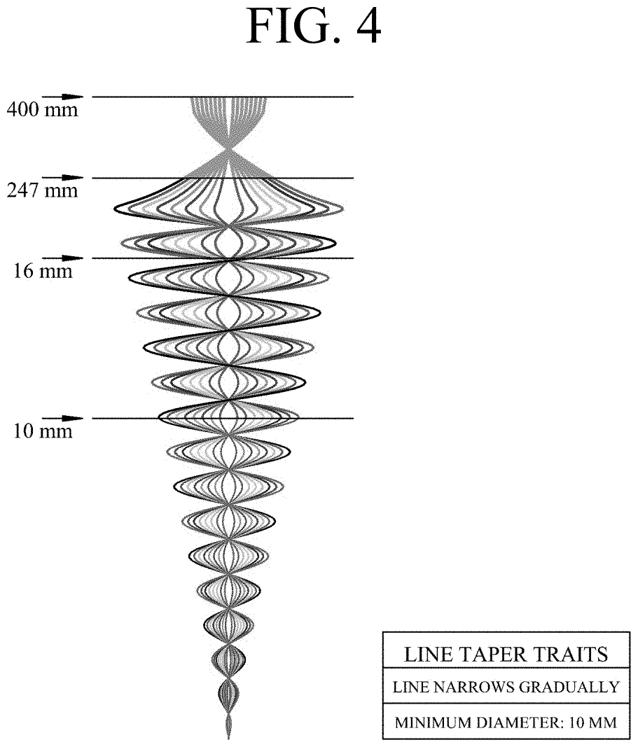

FIG. 4 demonstrates another unique feature of the SAPAs used in this invention, being that the opening diameter of the adjustable-power accelerator pumping lines is large-400 mm—but each line gradually tapers to a much smaller size-10 mm—which allows for a natural increase in pressure while making the terminus of each pumping line sufficiently compact to fit within the inner core of the invention.

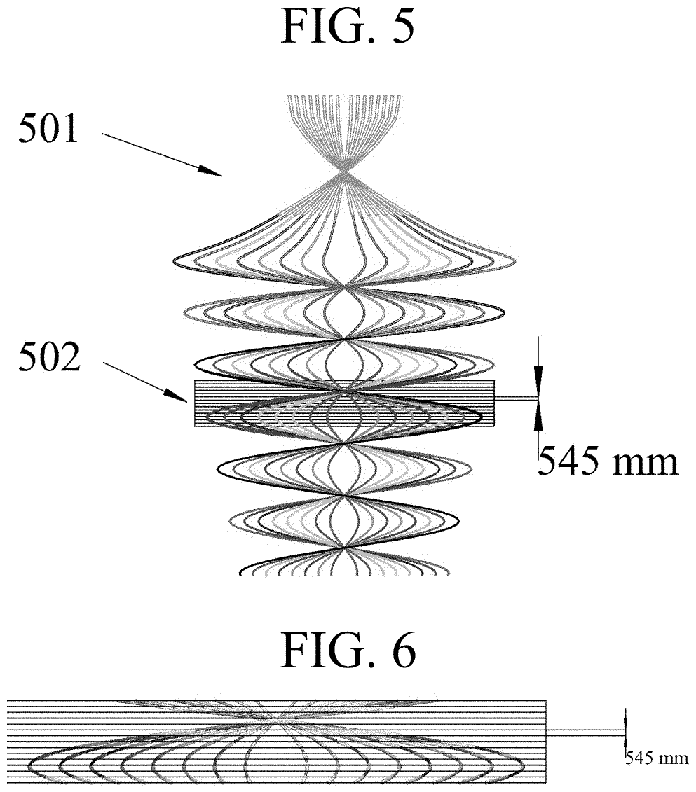

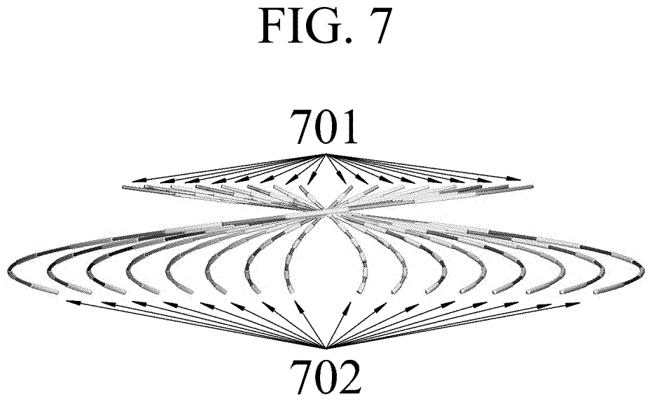

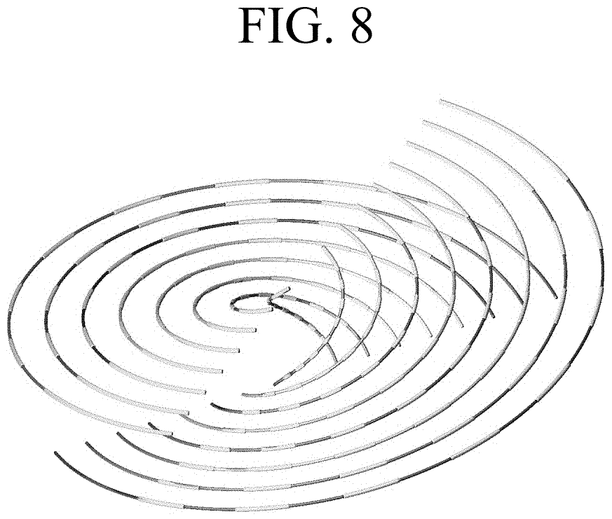

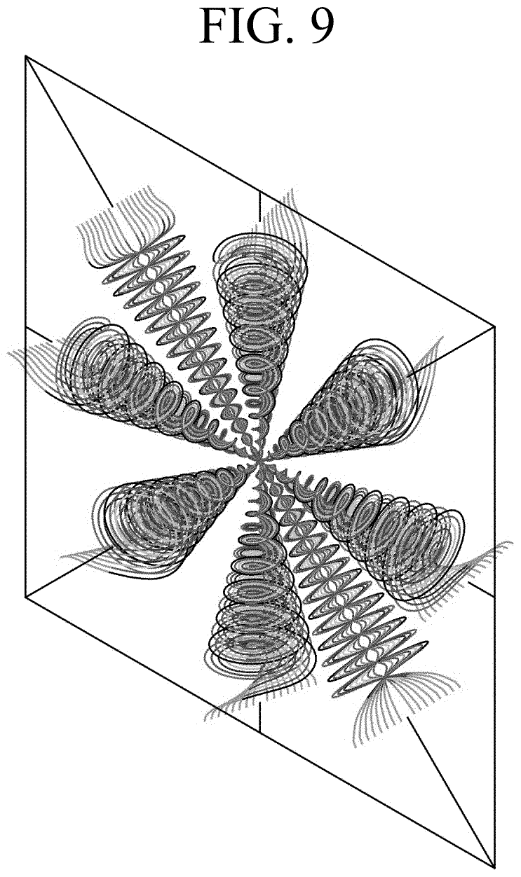

FIG. 5, FIG. 6, FIG. 7, and FIG. 8 demonstrate how magnetic accelerator components are to be spaced along the length of the SAPA pumping coils. Magnetic accelerator components run the entirety of the pumping lines (excluding the EPCC regions), with FIG. 5 simply indicating the region from which FIG. 6, FIG. 7, and FIG. 8 are all drawn. FIG. 8 is distinct from the other figures in that it demonstrates how EACs are positioned on a section of a SAPA as it approaches the core.

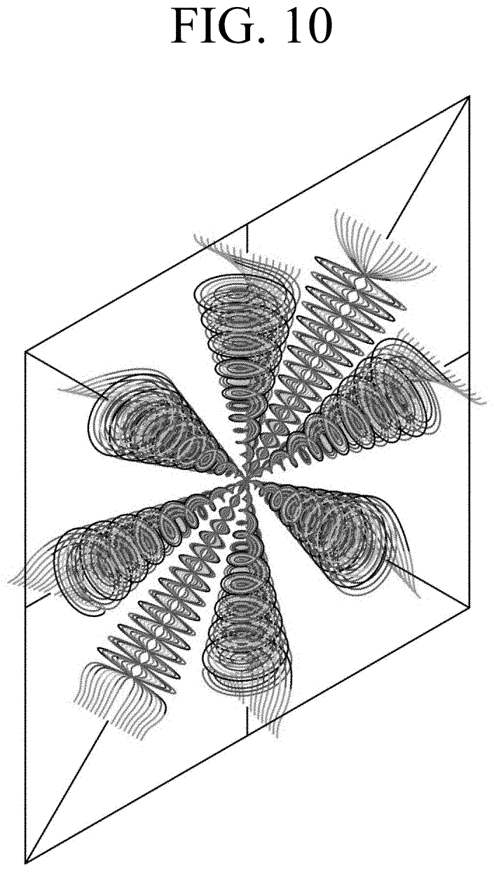

FIG. 9 and FIG. 10 provide a view of the entire embodiment of the invention from different angles found in FIG. 1. These isometric views demonstrate yet another advantage of the present invention—all pumping lines can be easily accessed for repair and maintenance, without disrupting any other part of the system. The large black frame outside of the embodiment indicates the front/rear plane of the rendering, but the frame is not a part of the invention.

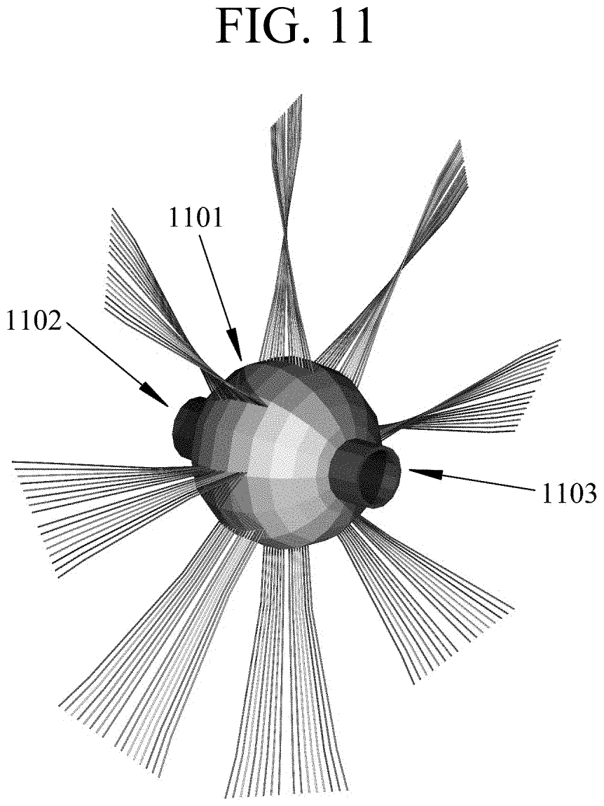

FIG. 11 illustrates the pumping lines passing through the outer shell of the core of the invention. It also shows how the placement of cooling ports allows heat created in the compression process to be transferred from the inner shell to a moving coolant. The placement of these cooling ports allows for the uninterrupted operation of the invention and precise control of the inner core temperature by way of adjusting the coolant flow rate.

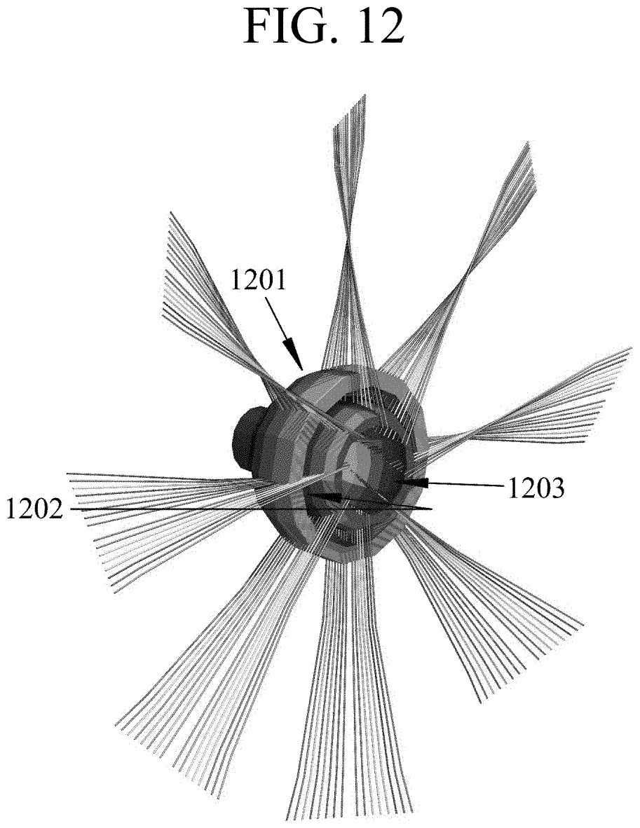

FIG. 12 demonstrates both the placement of the inner core within the outer core and how the pumping lines pass through both. It also clearly demonstrates the void between the two cores and the void's approximate diameter. If filled with a static high-pressure fluid, the void can also be used to hydraulically reinforce the inner core.

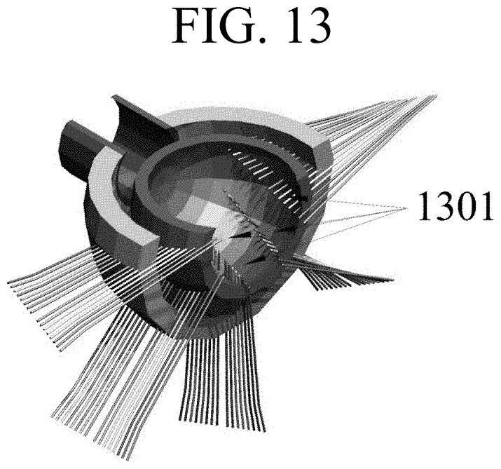

FIG. 13 is a view of the cores and their alignment and the alignment of the pumping lines as they pass through the inner core, and this illustrates another unique advantage of the present invention: The staggered entry of the pumping lines (1301) into the inner core allows for the creation of complex waves/fluid rotation patterns within the core. It also reduces the probability of collision of fluid streams as they enter the pressurized core.

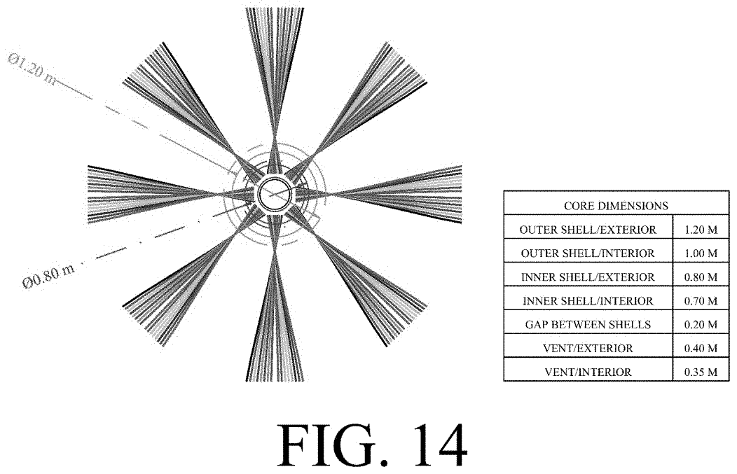

FIG. 14 demonstrates the precise dimensions of the core and the cooling channels.

### CONSTRUCTION OF INVENTION

The present invention may be constructed of metal of suitable toughness and corrosion resistance for its intended purpose, or it may be constructed of ceramic (the preferred embodiment). The ceramic construction method affords an advantage not commonly found in most other compressors, that being that every part of the invention can be made highly tolerant to heat and chemical attack. If the ceramic material used permits electromagnetic energy to pass through it without distortion, then no metal will contact or risk contacting fluids within any part of the invention. Additionally, the EACs may be constructed of appropriately arranged superconducting ceramic electromagnets, which would offer considerable power and efficiency advantages compared to conventional electromagnets.

The SAPA pumping lines may be made by any method appropriate to the material used, with the casting, polishing, milling, or Selective Laser Melting methods being appropriate, so long as the pumping lines are made to the specified size and diameter and are manufactured with sufficient precision and of appropriate materials to be impervious to any fluid compressed by the invention.

The pumping lines of the SAPAs may be made of either a single piece or several pieces joined by way of tension joint, welding, chemical adhesion, or fusion by heat and pressure.

The EPCCs and EACs may be attached to the pumping lines with any method appropriate to the material, so long as this method or adhesive does not interfere with the transmission of electrostatic or electromagnetic forces.

At the points where they meet the cores (inner and outer), the SAPA pumping lines should join the cores with a tight seal sufficient to prevent leakage. SAPA pumping lines and core shells may be fused/joined with any technique appropriate for creating an adequate seal, including tension fit, welding, or chemical adhesion. Alternately, the section of the pumping lines that intersects the cores and the cores themselves may be cast or fabricated from a single piece of ceramic so that there are no seals or joints to be compromised.

### OPERATION OF INVENTION

Operation of the invention is to be conducted as follows:
1. The operator selects fluids, either of one type or a suitable combination of types, for acceleration, mixing, and compression. Any fluids chosen must be capable of maintaining an electrostatic charge.
2. The fluids to be compressed are injected into their respective electrostatic-pre-charging components (EPCCs) (201) by way of any system that allows for fluids to be pumped without contamination and at a rate appropriate to the intended final flow/compression objective.
3. The EPCCs are activated, charging the fluids.
4. External pumping continues, pushing the fluids further into the SAPA.
5. The fluids pass through the inert/inactive part of the pumping lines (701) until they reach the first of the electromagnetic accelerator components (EACs), where the fluids are accelerated by way of the magnetohydrodynamic effect (MHDE).
6. The fluids continue to accelerate through the SAPA, with velocity increasing as approaching/spiraling towards the core.
7. The fluids then pass through the outer core of the invention (1101/1201) by way of the SAPA lines, through the void between the outer and inner core (1202) and into the inner core (1203) by way of the pumping lines (1301).
8. The operator then begins pumping coolant through the cool/input side of the core cooling system (1102). The coolant then passes through the void between cores (1202) and exits the hot/output side of the cooling system (1103). If the operator wishes to increase pressure tolerance of the inner core, the operator will pump cooling fluid into the void and maintain it there at pressure, rather than allowing the fluid to cycle through.
9. Once the appropriate pressure levels and fluids combinations have been reached, the operator maintains inner core pressure as long as is necessary for the appropriate reaction/chemical/mechanical process to occur.
10. The operator then reduces or inverts the polarity of the power applied to the EACs (some of which can be seen in 702), which allows for the controlled release of the material contained in the core, either symmetrically (meaning by way of all SAPAs/pumping lines at the same rate and time) or asymmetrically (meaning from different SAPAs/pumping lines at different times).
11. The cooling system is deactivated (meaning that coolant stops flowing through 1102/1103) once a non-destructive core temperature has been reached.

### SCOPE OF CLAIMS

Although the present invention has been illustrated and described herein with reference to the preferred embodiments and specific examples thereof, it will be readily apparent to those of requisite skill in the art that other embodiments and examples may perform similar functions and/or achieve like results. All such equivalent embodiments and examples are within the spirit and scope of the present invention, are contemplated thereby, and are intended to be covered by the following claims:

What is claimed is:

1. A novel system that makes use of the magnetohydrodynamic effect (MHDE) to accelerate and compress particles into a confined space (the core) for mixing of fluids and/or chemical processing.

2. (A) The unique geometry and arrangement of the spiraled adjustable-power accelerators (SAPAs) in this invention and (B) the distinctive geometry of the pumping lines as they penetrate the inner core (1301), which results from the geometry of A when the pumping lines terminate in the core.

3. (A) A technique for controlling pressurization, rate of pressurization, timing of introduction of fluids, and rate of depressurization of an accelerator/compressor core by varying power levels applied to appropriately arranged electrostatic-pre-charging components (EPCCs) and electromagnetic accelerator components (EACs) and (B) the reversal of this process for either directional or omnidirectional core depressurization by way of decreasing or inverting EAC power and polarity, with the generation of electricity during this process being a natural result of the magnetohydrodynamic effect (MHDE).
